(19) United States
(12) Patent Application Publication
(10) Pub. No.: US 2020/0279187 A1
(43) Pub. Date: Sep. 3, 2020

(54) MODEL AND INFRASTRUCTURE HYPER-PARAMETER TUNING SYSTEM AND METHOD

(71) Applicant: Cisco Technology, Inc., San Jose, CA (US)

(72) Inventors: Xinyuan Huang, San Jose, CA (US); Debojyoti Dutta, Santa Clara, CA (US)

(21) Appl. No.: 16/288,563

(22) Filed: Feb. 28, 2019

(51) Int. Cl. G06N 20/00; G06F 11/34

(52) U.S. Cl. CPC G06N 20/00; G06F 11/3428; G06F 11/3452

(57) ABSTRACT

Joint hyper-parameter optimizations and infrastructure configurations for deploying a machine learning model can be generated based upon each other and output as a recommendation. A model hyper-parameter optimization may tune model hyper-parameters based on an initial set of hyper-parameters and resource configurations. The resource configurations may then be adjusted or generated based on the tuned model hyper-parameters. Further model hyper-parameter optimizations and resource configuration adjustments can be performed sequentially in a loop until a threshold performance for training the model based on the model hyper-parameters or a threshold improvement between loops is detected.

### FIELD

The present embodiments generally relate to machine learning in a cloud-based environment. In particular, the present embodiments relate to tuning hyper-parameters and infrastructure configuration for performing machine learning tasks in a cloud-based environment.

### BACKGROUND

Machine learning models and tasks are often optimized by tuning a respective model hyper-parameters based on a fixed underlying infrastructure system. For example, certain performance sensitive hyper-parameters such as batch size, learning rate, epoch count, etc. can be chosen based on performance benchmarking and constraints of the fixed underlying infrastructure. However, with cloud and multi-cloud technology, infrastructure configurations can be rapidly adjusted and modified on-the-fly.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompany drawings in which:

FIG. 1 illustrates an example system for generating a joint hyper-parameter and infrastructure configuration recommendation, according to various embodiments of the subject technology;

FIG. 2 illustrates an example joint tuner and benchmarking dataflow, according to various embodiments of the subject technology;

FIG. 3 illustrates an example method for providing a joint hyper-parameter and infrastructure configuration recommendation, according to various embodiments of the subject technology;

FIG. 4 illustrates an example network device, according to various embodiments of the subject technology; and

FIG. 5 illustrates an example computing device, according to various embodiments of the subject technology.

### DESCRIPTION OF EXAMPLE EMBODIMENTS

Various embodiments of the disclosure are discussed in detail below. While specific representations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain cases, well-known or conventional details are not described in order to avoid obscuring the description. References to one or more embodiments in the present disclosure can be references to the same embodiment or any embodiment; and, such references mean at least one of the embodiments.

References to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatuses, methods, and their related results according to the embodiments of the present disclosure are given below. Note that titles or subtitles may be used in the examples for convenience of a read, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure can be realized and obtained by means of the instruments and combinations particularly pointed out in the appended claims. These and other features of the disclosure will be become fully apparent from the following description and appended claims, or can be learned by the practice of the principles set forth herein.

### Overview

Machine learning workloads deployed over cloud and multi-cloud infrastructures can be tuned at both a model level and also an infrastructure configuration level. By using virtualization, resources can be deployed, decommissioned, and configured rapidly and dynamically. However, virtualized and distributed resources introduce a substantially larger number of variables to consider for optimizing and deploying a machine learning workload. A joint recommender can optimize machine learning workloads at both the model level (e.g., hyper-parameters, etc.) and the infrastructure configuration level (e.g., resource deployment, configuration, etc.) by performing sequential optimization processes tuning the model for a particular resource configuration, then tuning the resource configuration for the particular model, and repeating the process as needed until a fully optimized configuration is generated.

In one embodiment, an infrastructure configuration and hyper-parameters can be generated by using resource information received, for example, from a server or database. After receiving an initial set of hyper-parameters (e.g., operational training instructions for training a model), an infrastructure configuration can be generated based on the set of hyper-parameters and the resource information. A training iteration (e.g., an epoch, batch, etc.) can be run on the model using the set of hyper-parameters and infrastructure configuration, and a performance value can be generated based on the run. Additional hyper-parameters and/or infrastructure configurations can then be generated by modifying (e.g., optimizing or tuning, etc.) either the initial hyper-parameters or infrastructure configuration, and a second training iteration can be run on the additional hyper-parameters and/or infrastructure configurations to generate another performance value. An output can then be chosen based on a comparison of the performance values.

### Example Embodiments

Infrastructure and model configurations may be treated as an integrated system in order to produce a joint infrastructure configuration and model hyper-parameter recommendation. In particular, model hyper-parameters can be optimized for a particular infrastructure configuration while the particular infrastructure configuration is also tuned (e.g., optimized) for the model hyper-parameters. The produced joint recommendation can then be used, for example, to maximize a performance to cost ratio for machine learning workloads over a cloud infrastructure. As a result, the joint recommendation can enable deploying an optimized model over an optimized infrastructure configuration at the start of deployment, rather than performing optimizations to the model hyper-parameters or the infrastructure configuration (which, in some cases, may require redeployment) after deployment and training of the model has begun.

The joint recommendation can be produced by a joint tuner including testing and iteration processes. The joint tuner may include a tuning process and a benchmarking process. The benchmarking process may provide performance information to tuning process in order to sequentially tune hyper-parameters and then infrastructure configurations.

The joint tuner may perform a looping process between tuning hyper-parameters and infrastructure configurations. A listing of available infrastructure resources can be retrieved from one or more cloud providers. Infrastructure configuration constraints (e.g., cost, quota, etc.) and model hyper-parameters (e.g., batch sizes, learning rate, epoch counts, parallelization, etc.) can be received from a user.

An initial set of infrastructure configurations and model hyper-parameters can be generated according to the received model hyper-parameters and infrastructure configuration constraints in combination with the listing of available infrastructure resources. Available infrastructure resources, and infrastructure configuration constraints, may include and/or refer to categorical resource data (e.g., compute core models, memory type, etc.) as well as scaling resource data (e.g., number of compute cores, amount of memory, overclocking details, etc.). The initial infrastructure configurations can be generated in multiple ways.

For example, a base resource configuration can be adjusted on a resource-by-resource basis to conform to the constraints. In some examples, a hierarchy of resource adjustments may be applied based on the infrastructure configuration restraints such as selecting a first resource from a reduced tier of resources in a shared category with the first resource, a second resource from a reduced tier of resources in a shared category with the second resource, and so on until a resulting resource configuration adheres to the infrastructure configuration constraints.

In some examples, the infrastructure configurations may be generated randomly and adjusted as necessary to adhere to the infrastructure configuration restraints. In some examples, one of a set of predetermined infrastructure configurations associated with the infrastructure configuration constraints (e.g., by categorizing constraints automatically or via user input, by learned or probabilistic categorization/classification, etc.) can be selected as an initial infrastructure configuration. In some examples, the user may directly provide the initial infrastructure configuration (e.g., via survey, import, etc.).

Nevertheless, the tuning process can optimize the model by adjusting the hyper-parameters based on the initial infrastructure configuration. The tuning process may optimize the model for increased learning efficiency. In some examples, a user may provide specific goals to tune for, such as learning speed and the like instead of learning efficiency. Model optimizations may be probabilistic, or learned, and based on model deployment statistics.

The tuning process may then optimize the initial infrastructure configurations based on the optimized model in order to generate an optimized infrastructure configuration. The tuning process may generate multiple infrastructure configurations based on the optimized model and the infrastructure configuration constraints. Each generated infrastructure configuration can be tested by the benchmarking process to select the best performing configuration(s). In some examples, each generated configuration may be tested in parallel in order to increase efficiency. Each time a configuration is test by the benchmarking process (e.g., sequentially, in parallel, etc.), new virtual machines (VMs) may be deployed and new components may be assigned to the test. In effect, each benchmarking test may be initiated from a clean slate for each tested configuration.

In some examples, the infrastructure configurations can be generated by randomly selecting resources and configurations adhering to the constraints. In some examples, the infrastructure configurations may be iteratively generated as each one is tested by the benchmarking process in order to generate sequential infrastructure configurations based on results from the benchmarking process (e.g., via learning mechanisms, etc.).

The tuning process may then enter an optimization loop of optimizing the most recently optimized model based on the most recently optimized infrastructure configuration. In turn, the tuning process can then optimize the most recently optimized infrastructure configuration based on the most recently optimized model. This process may repeat itself until a stop condition is met. Further, in order to generate new infrastructure configurations, a likelihood of selecting a particular resource may be based on an interaction between resource cost and expected resource performance gain. In effect, resource cost can apply a negative pressure on, or suppress, the likelihood of the resource being selected while the expected performance gain may apply a positive pressure on, or increase, the likelihood of the resource being selected.

In some examples, the stop condition can be based on a threshold of cost to performance ratio of the model and the infrastructure configuration. In some examples the stop condition may be based on a threshold of improvement between iterations of the cost to performance ratio. For example, a calculation may be made at the top of every loop to determine a cost to performance ratio and whether the loop may proceed. If the calculated cost to performance ratio is sufficiently low (e.g., it is sufficiently inexpensive for the obtained performance level), then the loop may halt and the most recently optimized model (e.g., hyper-parameters) and the most recently optimized infrastructure configuration may be output to the user.

In some examples, the one or more most recently calculated cost to performance ratios (e.g., where the loop has run multiple times) may be stored in a buffer and, when a change (e.g., improvement) between the values of the buffer (e.g., a delta and/or a trend) is sufficiently small (e.g., indicating a small change in calculated cost to performance ratios between runs of the loop), then the loop may halt and the most recently optimized model and the most recently optimized infrastructure configuration can be output to the user.

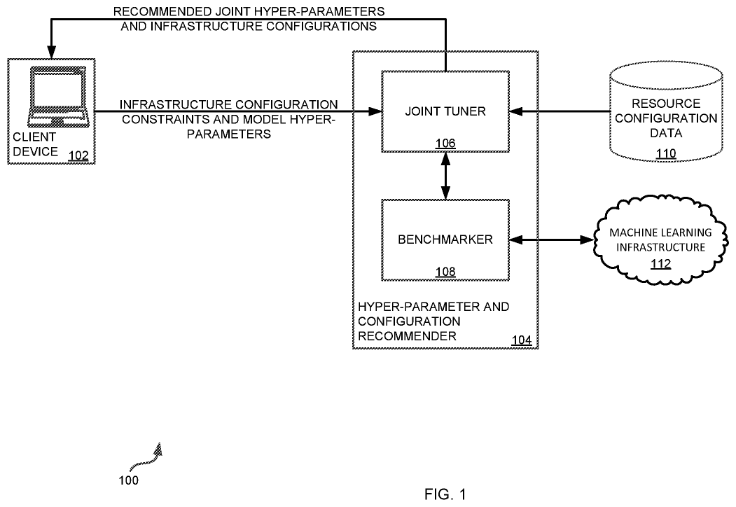

FIG. 1 is a diagram of a system 100 for generating recommended joint hyper-parameters and infrastructure configurations. Based on a set of infrastructure configuration constraints and initial model hyper-parameters for a machine learning model, system 100 may recommend an optimized set of hyper-parameters and optimized infrastructure configurations in order, for example, to attain an increased learning rate. While this disclosure discusses optimizations oriented towards increasing learning rate, it will be understood by a person having ordinary skill in the art that system 100 may generate recommended joint hyper-parameters oriented towards other optimizations (e.g., memory usage, resource cost, etc.) without departing from the content of this disclosure.

A client device 102 transmits infrastructure configuration constraints and a set of initial model hyper-parameters to a hyper-parameter and configuration recommender 104. Client device may be a computer, laptop, mobile device, stationary terminal, or other computing platform which can be configured to generate infrastructure constraints and model hyper-parameters, and transmit over a network, such as the Internet, to hyper-parameter and configuration recommender 104.

Hyper-parameter and configuration recommender 104 can include a joint tuner 106 and a benchmarker 108. Joint tuner 106 and benchmarker 108 can together perform optimizations on infrastructure configurations and machine learning models. In particular, joint tuner 106 and benchmarker 108 exchange information back and forth, performing a looping procedure, in order to alternate optimization of infrastructure configuration based on a set of model hyper-parameters and optimization of model hyper-parameters based on an infrastructure configuration.

Joint tuner 106 may retrieve resource information from a resource configuration data repository 110. Resource information may include resource characteristics such as performance measures, cost, interfaces, application programming interfaces (APIs), and the like, which may be used to construct and configure an integrated infrastructure (e.g., in which all components intercommunicate via APIs, channels, interfaces, and the like) for training a machine learning model. Joint tuner 106 may provide a hyper-parameter set and a determined infrastructure configuration to benchmarker 108 in order to determine performance information of the respective combination of infrastructure configuration and hyper-parameter.

Benchmarker 108 can configure a cloud hosted machine learning infrastructure 112 to train a machine learning model based on the combination of infrastructure configuration information and hyper-parameters received from joint tuner 106. In some examples, benchmarker 108 may execute a limited model training run over machine learning infrastructure 112 in order to ascertain learning rate, cost, and other perform characteristics. In some examples, benchmarker 108 may receive multiple paired infrastructure configurations and hyper-parameters (e.g., as tuples, dictionaries, etc.) in order to parallelize benchmarking processes from one or more joint tuners 106.

Nevertheless, benchmarker 108 may return performance information to joint tuner 106. Joint tuner 106 can then use the returned performance information to determine whether to recommend the paired infrastructure configuration and optimized hyper-parameters or to continue iterating through optimizations. In some examples, this determination can be performed by maintaining a most recent performance information and comparing the returned performance information to the most recent performance information. If the difference between the most recent performance information and the returned performance information is below a certain threshold value (e.g., it is too small), then optimizations may be determined to be complete and the respective infrastructure configuration and hyper-parameters may be returned to client device 102. Otherwise, joint tuner 106 may generate a new set of infrastructure configurations and optimized hyper-model parameters to provide to benchmarker 108.

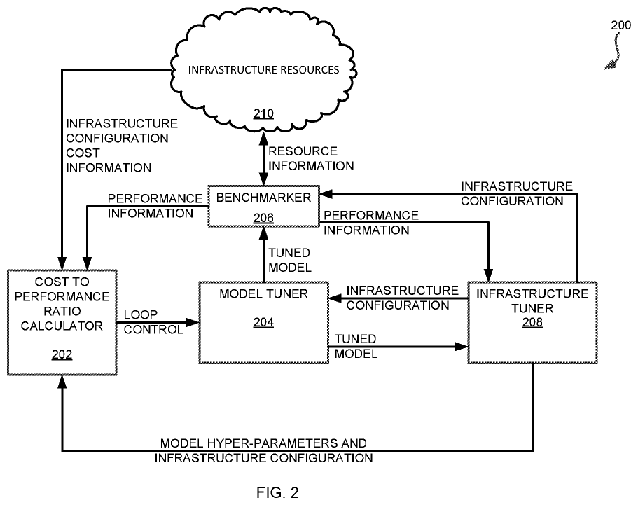

FIG. 2 depicts a joint tuner and benchmarking dataflow 200. Joint tuner and benchmarking dataflow 200 may be performed by system 100 discussed above. In particular, joint tuner and benchmarking dataflow 200 loops through tuning and testing processes until a substantially optimized infrastructure configuration and model hyper-parameter set has been generated and tested.

A cost to performance ratio calculator 202 determines whether to continue the looping dataflow based on cost, performance, and hyper-parameter and resource configuration information. Cost to performance ratio calculator 202 may receive infrastructure configuration cost information from infrastructure resources 210 via direct communication to resource components of infrastructure resources 210 or via API call or the like to a cloud hypervisor or management utility. Performance information can be received from a benchmarker 206, and hyper-parameter and resource configuration information may be received from an infrastructure tuner 210.

In some examples, cost to performance ratio calculator 202 may include a buffer, queue, list, or other similar data structure for retaining a history of calculated cost to performance ratios for previous iterations against which a most recent cost to performance ratio may be compared. Based on the comparison, cost to performance ratio calculator 202 may send a loop control signal to model tuner 204 to continue (or end) the loop.

Model tuner 204 can tune a model hyper-parameters based on an infrastructure configuration (e.g., as discussed above). The infrastructure configuration may be received from an infrastructure tuner 208 (e.g., as a tuned infrastructure configuration). Model tuner 204 may send the tuned model to infrastructure tuner 208 and benchmarker 206. Infrastructure tuner 208 may tune or generate an infrastructure configuration based on the tuned model (e.g., as discussed above). In comparison, benchmarker 206 may use the tuned model to benchmark (e.g., determine performance characteristics) a paired tuned infrastructure configuration and model hyper-parameter set.

Infrastructure tuner 208 may tune or generate an infrastructure configuration based on model hyper-parameter information received from model tuner 204 For example, infrastructure tuner 208 may include configuration values (e.g., resource models or vendors, resource functions such as clock speed, etc.) associated with particular hyper-parameter settings or combinations of settings. In some examples, the configuration value associations may be based upon probabilistic or learned processes (e.g., based upon prior joint hyper-parameter and infrastructure configuration generation and/or updated regularly).

Infrastructure tuner 208 may send the generated infrastructure configuration to benchmarker 206 to benchmark the infrastructure configuration using tuned model hyper-parameters (as discussed above). Benchmarker 206 may deploy resources of infrastructures resources 210 according to the received infrastructure configuration and execute a portion of training a model (e.g., over the deployed resources) using the tuned model hyper-parameters. Performance information may be provided to infrastructure tuner 208 for iterating a new infrastructure configuration and/or updating associations between hyper-parameters and resources. Benchmarker 206 may also provide the performance information to cost to performance ratio calculator 202 (as discussed above).

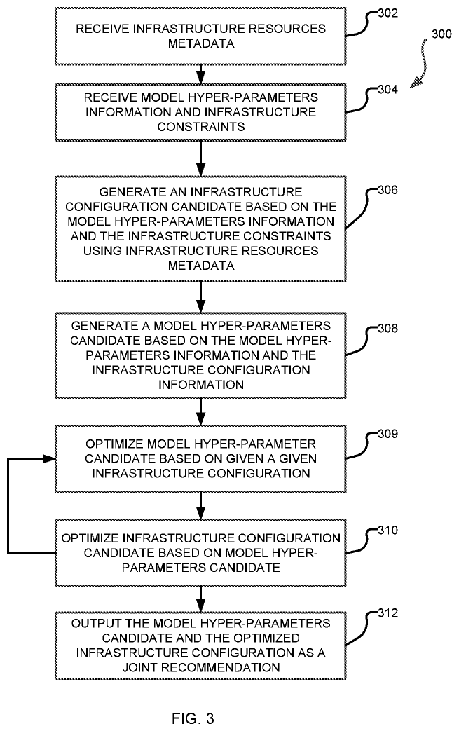

FIG. 3 depicts a method 300 for generating recommended model hyper-parameters and infrastructure configurations. Method 300 may be performed, for example, by system 100. At step 302, resources infrastructure resources metadata are received, which may include resource information for a machine learning infrastructure such as location information, interface protocols, cost information, and the like.

At step 304, hyper-parameters for a model and infrastructure constraints information are received. Hyper-parameters may include learning rate, step size, epoch information, and the like. Constraints information can include budget information (e.g., ability to cover resource costs), speed information, model/vendor preferences, and other information for restricting choice of resource from a machine learning infrastructure for training models.

At step 306, the model hyper-parameters and infrastructure constraints can be used to generate an infrastructure configuration using the infrastructure resources metadata. The generated infrastructure configuration may then be used as an initial infrastructure configuration to initiate a loop at step 308.

At step 308, a model hyper-parameters candidate can be generated based on the preceding hyper-parameters information and the infrastructure configuration information. The model hyper-parameters candidate may be optimized for the infrastructure configuration information.

At step 309, the model hyper-parameters candidate can be optimized based on a given infrastructure configuration. In a first execution of method 300, the given infrastructure configuration may be an unoptimized infrastructure configuration (e.g., the infrastructure configuration candidate generated at step 306 above). However, as discussed below, the given infrastructure configuration may also include an optimized infrastructure (e.g., such as in second, third, fourth, etc. iterations of an optimization loop). At step 310, the infrastructure configuration may be optimized based on the generated model hyper-parameters candidate. As mentioned above, steps 309-310 may continue to loop until a threshold (e.g., cost to performance ratio, performance, cost, etc.) is attained.

At step 312, once steps 308-310 have concluded looping, the model hyper-parameters candidate and optimized infrastructure configuration may be output as a joint recommendation. In some examples, the output may be provided to a computing device such as a computer, mobile device, terminal, etc. In some examples, the output may be provided to downstream services for further processing such as, for example and without imputing limitation, automated deployment, validation, storage, etc.

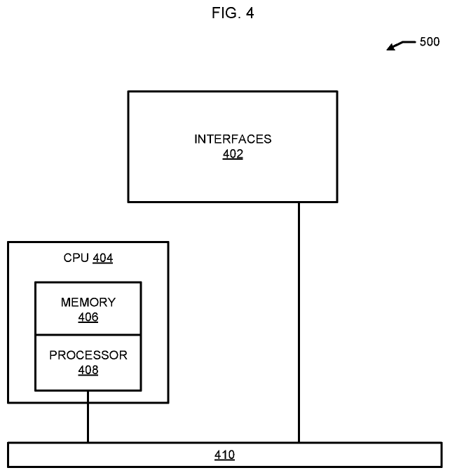

Although the system shown in FIG. 4 is one specific network device of the present disclosure, it is by no means the only network device architecture on which the concepts herein can be implemented. For example, an architecture having a single CPU 404 that handles communications as well as computations, etc., can be used. Further, other types of interfaces and media could also be used with the network device 400.

Regardless of the network device's configuration, it may employ one or more memories or memory modules (including memory 406) configured to store program instructions for the functions described herein. The program instructions may control the operation of an operating system and/or one or more applications, for example. The memory or memories may also be configured to store tables such as bindings, registries, etc. Memory 406 could also hold various software containers and virtualized execution environments and data.

The CPU 404 may include the memory 406, for example, as a cache memory to be accessed by a processor 408 which may be configured to perform the functions and methods described herein. The CPU 404 may access external devices, such as other network devices, over a network via interfaces 402. Interfaces 402 can include various network connection interfaces such as Ethernet, wireless, and radio, etc.

The network device 400 can also include an application-specific integrated circuit (ASIC), which can be configured to perform network configuration, hyper-parameter configuration, and other processes described herein. The ASIC can communicate with other components in the network device 400 via the connection 410, to exchange data and signals and coordinate various types of operations by the network device 400.

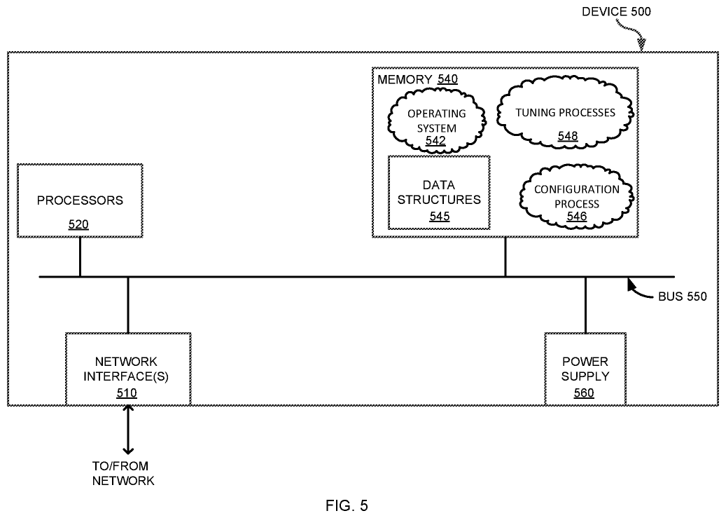

FIG. 5 is a schematic block diagram of an example computing device 500 that may be used with one or more embodiments described herein e.g., as any of the discussed above or to perform any of the methods discussed above, and particularly as specific devices as described further below. The device may comprise one or more network interfaces 510 (e.g., wired, wireless, etc.), at least one processor 520, and a memory 540 interconnected by a system bus 550, as well as a power supply 560 (e.g., battery, plug-in, etc.).

Network interface(s) 510 contain the mechanical, electrical, and signaling circuitry for communicating data over links coupled to the system 100, e.g., providing a data connection between device 500 and the data network, such as the Internet. The network interfaces may be configured to transmit and/or receive data using a variety of different communication protocols. For example, interfaces 510 may include wired transceivers, wireless transceivers, cellular transceivers, or the like, each to allow device 500 to communicate information to and from a remote computing device or server over an appropriate network. The same network interfaces 510 also allow communities of multiple devices 500 to interconnect among themselves, either peer-to-peer, or up and down a hierarchy. Note, further, that the nodes may have two different types of network connections 510, e.g., wireless and wired/physical connections, and that the view herein is merely for illustration. Also, while the network interface 510 is shown separately from power supply 560, for devices using powerline communication (PLC) or Power over Ethernet (PoE), the network interface 510 may communicate through the power supply 560, or may be an integral component of the power supply.

Memory 540 comprises a plurality of storage locations that are addressable by the processor 520 and the network interfaces 510 for storing software programs and data structures associated with the embodiments described herein. The processor 520 may comprise hardware elements or hardware logic adapted to execute the software programs and manipulate the data structures 545. An operating system 542, portions of which are typically resident in memory 540 and executed by the processor, functionally organizes the device by, among other things, invoking operations in support of software processes and/or services executing on the device. These software processes and/or services may comprise one or more configuration processes 546 which, on certain devices, may be used by an illustrative tuning process 548, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Statements follow describing various aspects of a budgeted neural network architecture search:

Statement 1: A method for generating an infrastructure configuration and hyper-parameters for a machine learning model may include receiving resource information associated with configurable resources of a cloud provider receiving an initial set of hyper-parameters for training a model, the hyper-parameters comprising operational training parameters for the model, generating an initial infrastructure configuration for training the model based on the initial set of hyper-parameters and the received resource information, performing one or more initial training iterations on the model using the initial infrastructure configuration and the initial set of hyper-parameters to generate a first performance value, generating one of a second set of hyper-parameters or a second infrastructure configuration by modifying one of the initial set of hyper-parameters or the initial infrastructure configuration, performing one or more second training iterations on the model using at least one of the second set of hyper-parameters or the second infrastructure configuration to generate a second performance value, and outputting, based on a comparison of the first performance value and the second performance value, an optimized infrastructure and hyper-parameters comprising one of the second set of hyper-parameters or the second infrastructure configuration.

Statement 2: The method of Statement 1 can further generating one or more additional sets of hyper-parameters or infrastructure configurations, performing training iterations over each of the one or more additional sets of hyper-parameters or infrastructure configurations to generate respective performance values for each set of hyper-parameters or infrastructure configuration, and determining that a stop condition has been met by one of the respective performance values, the stop condition comprising a threshold value achieved by the one of the respective performance values, wherein the outputted optimized infrastructure and hyper-parameters correspond to the one of the respective performance values.

Statement 3: The method of any of Statement 2 can include the training iterations performed, at least in part, in parallel.

Statement 4: The method of any of the preceding Statements can include the performance values including a learning rate or an infrastructure configuration cost.

Statement 5: The method of any of the preceding Statements can include the initial infrastructure configuration being received from a user device.

Statement 6: The method of any of the preceding Statements can include generating one of the initial infrastructure configuration or the second infrastructure configuration further including selecting a resource category based on the resource information and one of the initial set of hyper-parameters or the second set of hyper-parameters, and determining a resource scaling value based on the resource category, the resource scaling value included in one of the initial infrastructure configuration or the second infrastructure configuration.

Statement 7: The method of any of the preceding Statements can include generating the second infrastructure configuration being based upon cost values included in the resource information or upon anticipated performance values included in the resource information, the cost values inverse proportional to a likelihood of an associated resource being included in the second infrastructure configuration and the performance values directly proportional to the likelihood of the associated resource being included in the second infrastructure configuration.

Statement 8: A system for generating an infrastructure configuration and hyper-parameters for a machine learning model may include one or more processors, and a memory storing instructions that, when executed by the one or more processors, cause the one or more processors to receive resource information associated with configurable resources of a cloud provider, receive an initial set of hyper-parameters for training a model, the hyper-parameters comprising operational training parameters for the model, generate an initial infrastructure configuration for training the model based on the initial set of hyper-parameters and the received resource information, perform one or more initial training iterations on the model using the initial infrastructure configuration and the initial set of hyper-parameters to generate a first performance value, generate one of a second set of hyper-parameters or a second infrastructure configuration by modifying one of the initial set of hyper-parameters or the initial infrastructure configuration, perform one or more second training iterations on the model using at least one of the second set of hyper-parameters or the second infrastructure configuration to generate a second performance value, and output, based on a comparison of the first performance value and the second performance value, an optimized infrastructure and hyper-parameters comprising one of the second set of hyper-parameters or the second infrastructure configuration.

Statement 9: A non-transitory computer readable medium storing instructions that, when executed by one or more processors, may cause the one or more processors to receive resource information associated with configurable resources of a cloud provider, receive an initial set of hyper-parameters for training a model, the hyper-parameters comprising operational training parameters for the model, generate an initial infrastructure configuration for training the model based on the initial set of hyper-parameters and the received resource information, perform one or more initial training iterations on the model using the initial infrastructure configuration and the initial set of hyper-parameters to generate a first performance value, generate one of a second set of hyper-parameters or a second infrastructure configuration by modifying one of the initial set of hyper-parameters or the initial infrastructure configuration, perform one or more second training iterations on the model using at least one of the second set of hyper-parameters or the second infrastructure configuration to generate a second performance value, and output, based on a comparison of the first performance value and the second performance value, an optimized infrastructure and hyper-parameters comprising one of the second set of hyper-parameters or the second infrastructure configuration.

What is claimed is:

1. A method for generating an infrastructure configuration and hyper-parameters for a machine learning model, the method comprising:
receiving resource information associated with configurable resources of a cloud provider;
receiving an initial set of hyper-parameters for training a model, the hyper-parameters comprising operational training parameters for the model;
generating an initial infrastructure configuration for training the model based on the initial set of hyper-parameters and the received resource information;
performing one or more initial training iterations on the model using the initial infrastructure configuration and the initial set of hyper-parameters to generate a first performance value;
generating one of a second set of hyper-parameters or a second infrastructure configuration by modifying one of the initial set of hyper-parameters or the initial infrastructure configuration;
performing one or more second training iterations on the model using at least one of the second set of hyper-parameters or the second infrastructure configuration to generate a second performance value; and
outputting, based on a comparison of the first performance value and the second performance value, an optimized infrastructure and hyper-parameters comprising one of the second set of hyper-parameters or the second infrastructure configuration.

2. The method of claim 1, further comprising:
generating one or more additional sets of hyper-parameters or infrastructure configurations;
performing training iterations over each of the one or more additional sets of hyper-parameters or infrastructure configurations to generate respective performance values for each set of hyper-parameters or infrastructure configuration; and
determining that a stop condition has been met by one of the respective performance values, the stop condition comprising a threshold value achieved by the one of the respective performance values, wherein the outputted optimized infrastructure and hyper-parameters correspond to the one of the respective performance values.

3. The method of claim 2, wherein the training iterations are performed, at least in part, in parallel.

4. The method of claim 1, wherein the performance values comprise one of a learning rate or an infrastructure configuration cost.

5. The method of claim 1, wherein the initial infrastructure configuration is received from a user device.

6. The method of claim 1, wherein generating one of the initial infrastructure configuration or the second infrastructure configuration further comprises:
selecting a resource category based on the resource information and one of the initial set of hyper-parameters or the second set of hyper-parameters; and
determining a resource scaling value based on the resource category, the resource scaling value included in one of the initial infrastructure configuration or the second infrastructure configuration.

7. The method of claim 1, wherein generating the second infrastructure configuration is based upon one of cost values included in the resource information or anticipated performance values included in the resource information, the cost values inverse proportional to a likelihood of an associated resource being included in the second infrastructure configuration and the performance values directly proportional to the likelihood of the associated resource being included in the second infrastructure configuration.

8. A system for generating an infrastructure configuration and hyper-parameters for a machine learning model, the system comprising:
one or more processors; and
a memory comprising instructions that, when executed by the one or more processors, cause the one or more processors to:
receive resource information associated with configurable resources of a cloud provider;
receive an initial set of hyper-parameters for training a model, the hyper-parameters comprising operational training parameters for the model;
generate an initial infrastructure configuration for training the model based on the initial set of hyper-parameters and the received resource information;
perform one or more initial training iterations on the model using the initial infrastructure configuration and the initial set of hyper-parameters to generate a first performance value;
generate one of a second set of hyper-parameters or a second infrastructure configuration by modifying one of the initial set of hyper-parameters or the initial infrastructure configuration;
perform one or more second training iterations on the model using at least one of the second set of hyper-parameters or the second infrastructure configuration to generate a second performance value; and
output, based on a comparison of the first performance value and the second performance value, an optimized infrastructure and hyper-parameters comprising one of the second set of hyper-parameters or the second infrastructure configuration.

9. The system of claim 8, wherein the memory further comprises instructions to:
generate one or more additional sets of hyper-parameters or infrastructure configurations;
perform training iterations over each of the one or more additional sets of hyper-parameters or infrastructure configurations to generate respective performance values for each set of hyper-parameters or infrastructure configuration; and
determine that a stop condition has been met by one of the respective performance values, the stop condition comprising a threshold value achieved by the one of the respective performance values, wherein the outputted optimized infrastructure and hyper-parameters correspond to the one of the respective performance values.

10. The system of claim 9, wherein the training iterations are performed, at least in part, in parallel.

11. The system of claim 8, wherein the performance values comprise one of a learning rate or an infrastructure configuration cost.

12. The system of claim 8, wherein the initial infrastructure configuration is received from a user device.

13. The system of claim 8, wherein generating one of the initial infrastructure configuration or the second infrastructure configuration further comprises:
select a resource category based on the resource information and one of the initial set of hyper-parameters or the second set of hyper-parameters; and
determine a resource scaling value based on the resource category, the resource scaling value included in one of the initial infrastructure configuration or the second infrastructure configuration.

14. The system of claim 8, wherein generating the second infrastructure configuration is based upon one of cost values included in the resource information or anticipated performance values included in the resource information, the cost values inverse proportional to a likelihood of an associated resource being included in the second infrastructure configuration and the performance values directly proportional to the likelihood of the associated resource being included in the second infrastructure configuration.

15. A non-transitory computer readable medium comprising instructions that, when executed by one or more processors, causes the one or more processors to:
receive resource information associated with configurable resources of a cloud provider;
receive an initial set of hyper-parameters for training a model, the hyper-parameters comprising operational training parameters for the model;
generate an initial infrastructure configuration for training the model based on the initial set of hyper-parameters and the received resource information;
perform one or more initial training iterations on the model using the initial infrastructure configuration and the initial set of hyper-parameters to generate a first performance value;
generate one of a second set of hyper-parameters or a second infrastructure configuration by modifying one of the initial set of hyper-parameters or the initial infrastructure configuration;
perform one or more second training iterations on the model using at least one of the second set of hyper-parameters or the second infrastructure configuration to generate a second performance value; and
output, based on a comparison of the first performance value and the second performance value, an optimized infrastructure and hyper-parameters comprising one of the second set of hyper-parameters or the second infrastructure configuration.

16. The non-transitory computer readable medium of claim 15, further comprising instructions to:
generate one or more additional sets of hyper-parameters or infrastructure configurations;
perform training iterations over each of the one or more additional sets of hyper-parameters or infrastructure configurations to generate respective performance values for each set of hyper-parameters or infrastructure configuration; and
determine that a stop condition has been met by one of the respective performance values, the stop condition comprising a threshold value achieved by the one of the respective performance values, wherein the outputted optimized infrastructure and hyper-parameters correspond to the one of the respective performance values.

17. The non-transitory computer readable medium of claim 15, wherein the performance values comprise one of a learning rate or an infrastructure configuration cost.

18. The non-transitory computer readable medium of claim 15, wherein the initial infrastructure configuration is received from a user device.

19. The non-transitory computer readable medium of claim 15, wherein the instructions to generate one of the initial infrastructure configuration or the second infrastructure configuration further comprise:
select a resource category based on the resource information and one of the initial set of hyper-parameters or the second set of hyper-parameters; and
determine a resource scaling value based on the resource category, the resource scaling value included in one of the initial infrastructure configuration or the second infrastructure configuration.

20. The non-transitory computer readable medium of claim 15, wherein generating the second infrastructure configuration is based upon one of cost values included in the resource information or anticipated performance values included in the resource information, the cost values inverse proportional to a likelihood of an associated resource being included in the second infrastructure configuration and the performance values directly proportional to the likelihood of the associated resource being included in the second infrastructure configuration.
